(19) United States
(12) Patent Application Publication
(10) Pub. No.: US 2023/0353391 A1
(43) Pub. Date: Nov. 2, 2023

(54) REMOTE PROVISIONING OF CERTIFICATES FOR MEMORY SYSTEM PROVENANCE

(71) Applicant: Micron Technology, Inc., Boise, ID (US)

(72) Inventor: Lance W. Dover, Fair Oaks, CA (US)

(21) Appl. No.: 18/127,546

(22) Filed: Mar. 28, 2023

Related U.S. Application Data
(60) Provisional application No. 63/335,583, filed on Apr. 27, 2022.

(51) Int. Cl. H04L 9/32

(52) U.S. Cl. CPC H04L 9/3268; H04L 9/3247

(57) ABSTRACT

Methods, systems, and devices for remote provisioning of certificates for memory system provenance are described. The method may include a server receiving a first certificate that includes a first public key, a first signature generated using a first private key of a memory system, and an indication of a characteristic associated with the memory system. The server may verify the first signature and that the characteristic associated with the memory system is a valid characteristic for the memory system to have. The server may generate a second certificate that includes the first public key and a second signature generated using a second private key. The server may provide the second certificate to a host system such that the host may verify the provenance of the memory system.

### CROSS REFERENCE

The present Application for Patent claims priority to U.S. Patent Application No. 63/335,583 by Dover, entitled “REMOTE PROVISIONING OF CERTIFICATES FOR MEMORY SYSTEM PROVENANCE,” filed Apr. 27, 2022, which is assigned to the assignee hereof, and which is expressly incorporated by reference in its entirety herein.

### FIELD OF TECHNOLOGY

The following relates to one or more systems for memory, including remote provisioning of certificates for memory system provenance.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports remote provisioning of certificates for memory system provenance in accordance with examples as disclosed herein.

FIGS. 2A, 2B, and 3 illustrate examples of systems that supports remote provisioning of certificates for memory system provenance in accordance with examples as disclosed herein.

FIG. 4 illustrates an example of a process flow that supports remote provisioning of certificates for memory system provenance in accordance with examples as disclosed herein.

FIG. 5 shows a block diagram of a server that supports remote provisioning of certificates for memory system provenance in accordance with examples as disclosed herein.

FIG. 6 shows a block diagram of a host system that supports remote provisioning of certificates for memory system provenance in accordance with examples as disclosed herein.

FIG. 7 shows a block diagram of a memory system that supports remote provisioning of certificates for memory system provenance in accordance with examples as disclosed herein.

FIGS. 8 through 10 show flowcharts illustrating a method or methods that support remote provisioning of certificates for memory system provenance in accordance with examples as disclosed herein.

### DETAILED DESCRIPTION

In some examples, a host system may be in communication with a memory system and transmit commands (e.g., access commands) to the memory system in order to access memory cells of one or more memory devices included in the memory system. A host system may desire to determine the authenticity of the memory system. For example, to determine the authenticity of the memory system, the host system may desire to verify the provenance of the memory system, where provenance may refer to an origin or source of the memory system (e.g., of hardware aspects of the memory system, of firmware or software aspects of the memory system, or of any combination thereof). As one such example, the host system may desire to verify that the memory device was in fact created by a particular manufacturer. Verifying the provenance of a memory system may prevent a malicious actor from selling counterfeit memory systems, introducing malware into systems, or any combination thereof, among other possible benefits.

In some cases, a manufacturer-generated cryptographic certificate or key may be written to a memory system at the time of manufacture for the memory system, and a host system may use various techniques to authenticate the memory system based on such a certificate or key. However, in some examples, characteristics of the memory device may change over time. For example, firmware or software of the memory device may be updated. Although a cryptographic certificate or key generated at the time of manufacture may verify that the memory device was created by a trusted manufacturer, it may not support verification that subsequent updates (e.g., firmware updates) are likewise supported or endorsed by the trusted manufacturer.

Provenance verification techniques as described herein may provide improved authentication of a memory system, including accounting for potential post-manufacture updates to firmware or other characteristics of a memory system. Techniques as described herein may further make use of asymmetric cryptography, in which a private key may be known to only to a system that has the private key, and a public key corresponding to the private key may be known to any system. A key as described herein may be a cryptographic key; a signature as described herein may be a cryptographic signature; and a certificate as described herein may be a cryptographic certificate.

As described herein, a server may serve as a source (e.g., repository) and distributor of manufacturer-endorsed certificates for memory systems, which may be used by a host system to authenticate a memory system. In some examples, the server may be an example of a cloud server that is owned and operated by or otherwise affiliated with the manufacturer. Additionally, the server may store a repository of memory device characteristics that are considered valid by the trusted manufacturer. For example, the sever may store a set of cryptographic digests (e.g., hash values) each corresponding to a respective version of firmware that is considered valid by the manufacturer (e.g., created by the manufacturer, not out-of-date). Such a repository may support the generation of new manufacturer-endorsed certificates as memory systems are updated. Where a server is described herein, it is to be understood that this may refer to any networked computing system capable of communicating with a host system and may include, for example, any quantity of physical servers.

A memory system may self-generate a first certificate based on a first private key at (e.g., generated by) the memory system. The first certificate may include a first public key (corresponding to—e.g., generated based on the first private key), a first signature generated using the first private key, and an indication of a characteristic of the memory system (e.g., a hardware characteristic, a firmware or software characteristic, or both-such as a hash value based on a firmware version as one example). The memory system may transmit the first certificate to a host system in response to a request from the host system. Additionally or alternatively, the memory system may transmit the first certificate to the server, in response to a request from the host system or the server, or proactively based on generating the first certificate. In general, when information is described herein as sent from a memory system to a server or as received by a memory system from a server, it is to be understood that a host system for the memory system may serve as a relay for such information, with the host system communicatively coupled with both the memory system and the server.

Upon receiving the first certificate, the server may verify the first signature included in the first certificate using the first public key included in the first certificate. For example, a signature may be an encrypted version of some information, the encryption based on a private key. An entity that receives the signature may verify the signature by decrypting the signature using the public key and verifying that the decrypted version of the signature matches the information. For a certificate that includes a signature, the information may be some or all of the certificate contents (e.g., other than the signature). Verifying a signature may confirm that the signature was in fact generated by an entity having the private key corresponding to the public key associated with the signature A private key used to sign a certificate may itself be considered a certificate authority or may be considered to be associated with a certificate authority. Thus, for a first certificate generated by a memory system, the corresponding first private key may be considered an embedded certificate authority included in the memory system, and verifying the first signature included in the first certificate may be considered as verifying that the first certificate is endorsed by the embedded certificate authority.

The server may also compare the characteristic indicated by the first certificate to characteristics included in the repository. If the characteristic indicated by the first certificate matches any of the characteristics included in the repository, the server may determine that the characteristic is valid (e.g., corresponds to a valid version of firmware). If the server determines that the characteristic is valid (e.g., and successfully verifies the first signature), the server may generate a second certificate. Additionally or alternatively, the server may attempt to recreate the first certificate. In some examples, the server may have knowledge associated with the memory system. For example, the server may have access to the private key and public key pair stored at the memory system. Using this knowledge, the server may create a certificate and compare the certificate to the first certificate. If the certificate and the first certificate match, the server may verify that the first certificate is valid and may generate the second certificate. The second certificate may include the first public key (that is, the same public key included in the first certificate generated by the memory system) and a second signature generated using a second private key (e.g., a private key stored at the server, which may correspond to a second certificate authority). The second certificate may further include information that may allow a recipient of the second certificate to obtain a second public key corresponding to the second private key (e.g., to support verification of the second signature by a recipient of the second certificate). The second certificate may in some cases further include a second indication of the characteristic of the memory system (e.g., matching the indication in the first certificate).

Thus, two certificates may be used to authenticate a memory system, including in a way that may include the authentication of updates (e.g., firmware updates) to the memory system. The memory system may generate a first certificate using a first private key at the memory system (e.g., acting as its own certificate authority, self-signing the first certificate). The server may generate a second certificate upon verifying the first certificate, including the validity of a memory system characteristic indicated by the first certificate, using a second private key (e.g., acting as a second certificate authority). Further, the server may act as a trusted repository and distributor of such second certificates, which may allow a host system to authenticate a memory system based on such a second (e.g., server-generated) certificate, either alone or in combination with a corresponding first (e.g., memory system-generated) certificate.

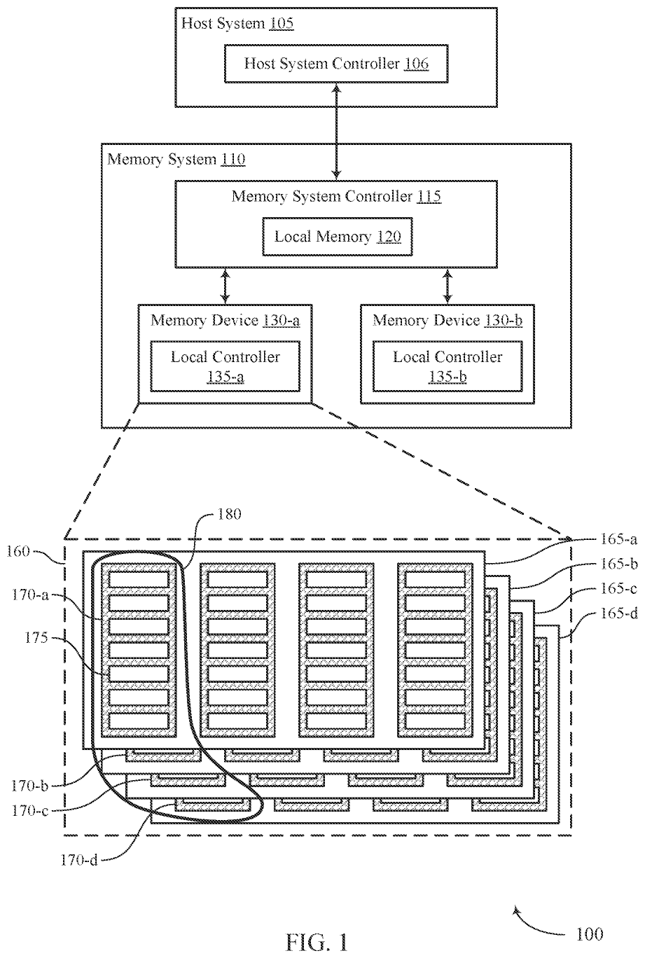

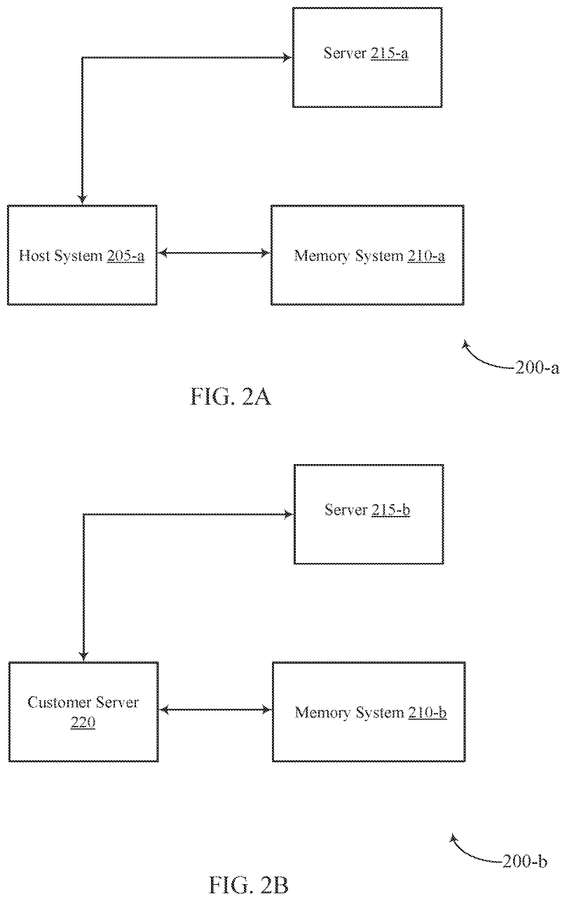

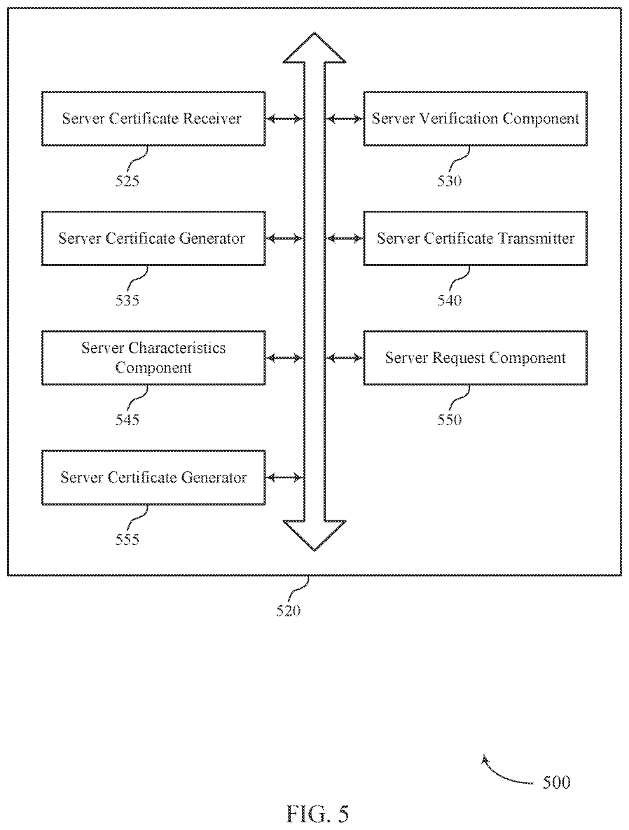

Features of the disclosure are initially described in the context of systems with reference to FIG. 1. Features of the disclosure are described in the context of device diagrams and a process flow with reference to FIGS. 2-4. These and other features of the disclosure are further illustrated by and described in the context of an apparatus diagram and flowchart that relate to remote provisioning of certificates for memory system provenance with reference to FIGS. 5-10. Though examples may be provided herein as related to memory devices and verifying the provenance of memory devices, it is to be understood that the teachings herein may be applied to any type of semiconductor or electronic device and verifying the provenance of any type of semiconductor or electronic device. For instance, for any example described herein, any type of semiconductor or electronic device may be substituted for a described memory device.

FIG. 1 illustrates an example of a system 100 that supports remote provisioning of certificates for memory system provenance in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include an embedded Multi-Media Controller (eMMC) device, a Universal Flash Storage (UFS) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b. 170-c, and 170-d that are within planes 165-a, 165-b, 165-c, and 165-d, respectively, and blocks 170-a, 170-b. 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support remote provisioning of certificates for memory system provenance. For example, the host system 105, the memory system controller 115, or a memory device 130 (e.g., a local controller 135) may include or otherwise may access one or more non-transitory computer readable media storing instructions (e.g., firmware) for performing the functions ascribed herein to the host system 105, memory system controller 115, or memory device 130. Such instructions may in some case be updated, which may correspond to an update of a characteristic of the memory system 110 as described herein. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

The methods as described herein may allow a host system 105 to verify the provenance of a memory system 110, including in the event that one or more characteristics of the memory system 110 change. To support such a verification procedure, one or both of the memory system 110 or the host system 105 may be in communication with a server (not shown). The server may be an example of a cloud server that is managed by a trusted certificate authority (e.g., corresponding to a trusted device manufacturer that manufactured or is purported to have manufactured the memory system 110). The server may store a set of characteristics associated with the memory system 110, where each characteristic of the set of characteristics is endorsed by the certificate authority. An example of the characteristic may be firmware or software for operating the memory system 110 (e.g., firmware for operating the memory system controller 115, a local controller 135, or any combination thereof).

The memory system 110 may update a characteristic of the memory system 110 and in response to the updating, generate a first certificate. The first certificate may include a first public key, a first signature generated using a first private key, and an indication of the updated characteristic. The server may receive the first certificate (e.g., by way of the host system 105) and compare the updated characteristic to the set of characteristics. If the updated characteristics matches one characteristic of the set of characteristics (e.g., and the first signature is successfully verified by the server), the server may determine that the memory device is authentic and generate a second certificate. The second certificate may include the first public key, along with a second signature generated using a second private key stored at the server. In addition, the second certificate may include information that allows a recipient of the second certificate to obtain a second public key corresponding to the second private key. As an example, the second certificate may reference a third certificate that includes the second private key and the host system may extract the second public key from the third certificate. The server may transmit the second certificate to the host system 105 or to the memory system 110 (e.g., by way of the host system 105). The host system 105 may receive the second certificate from the memory system 110 or directly from the server and verify the second signature (e.g., using a corresponding second public key, which may also be included in the second certificate). In some cases, the host system 105 may also verify that the first public key, as indicated by the second certificate, matches the first public key as indicated by the first certificate. Thus, the host system 105 may verify that the memory system 110, including any updates thereto, are authentic and have the trusted manufacture as their source. Techniques described here for authenticating a memory system 110 may additionally or alternatively be used to authenticate an individual memory device 130 within a memory system 110.

FIGS. 2A and 2B illustrate examples of a system 200 (e.g., a system 200-a and a system 200-b) that supports remote provisioning of certificates for memory system provenance in accordance with examples as disclosed herein. In some examples, the system 200 may implement aspects of a system 100. For example, the system 200 may include a host system 205, and a memory system 210, which may be examples of a host system 105, a memory system 110, and a memory device 130 as described in FIG. 1. In the example of the system 200-a, the memory system 210-a may be in communication with the host system 205-a, and the host system 205-a may be in communication with the server 215-a. In the example of the system 200-b, the memory system 210-b may be in communication with the customer server 220 and the customer server 220 may be in communication with the server 215-b. The server 215 (e.g., server 215-a, server 215-b) may be a cloud server, which may be described as a virtual server that may be accessed by devices remotely over a network. As such, devices that are in communication with the server 215 (e.g., the host system 205 and the customer server 220) may include components that enable network capabilities. Alternatively, other devices that are coupled to the host system 205 (not shown) may include components that enable network capabilities.

In some examples, the server 215 may be owned and managed by a manufacturer of the memory system 210 and may store (e.g., in a repository) indications of a set of characteristics that may be validly associated with the memory system 210. The set of characteristics may include possible characteristics that would be valid for the memory system 210 to have (e.g., possible updated versions of a characteristic associated with the memory system 210). That is, the set of characteristics may be hardware characteristics, firmware characteristics, or software characteristics (e.g., indicia thereof, such as hashes of corresponding information or contents) associated with (e.g., implemented by, imparted by, produced by) a manufacturer of the memory system 210 (e.g., as opposed to different characteristics that would correspond to a counterfeit or maliciously altered system).

For example, the manufacturer may configure a memory system 210 to have a first characteristic (e.g., a first firmware version), and the manufacturer may later update the memory system 210 to have a second characteristic (e.g., a second firmware version). In such an example, the server 215 may store the first characteristic and the second characteristic as valid characteristics that the memory system 210 may have. Alternatively, the server 215 may store the second characteristic but not the first characteristic, as the first characteristic may be considered obsolete and no longer valid-hence the set of characteristics stored at the server 215 may be updated over time. If a malicious actor were to modify the memory system 210 to have (or manufacture a counterfeit version of the memory system 210 having) a third characteristic (e.g., a malware or counterfeit version of the firmware), the server 215 may not store the third characteristic. In some examples, the set of characteristics may include characteristics of firmware or software for operating the memory system 210, characteristics of memory system 210 hardware, or combinations thereof. In some cases, a hash value based on a characteristic of a memory system 210 may be considered a type of characteristic of the memory system 210.

In the example of a system 200-a, the host system 205-a may transmit a first request to verify memory system provenance to the memory system 210-a. The host system 205-a may transmit a request to verify memory system provenance as part of an initialization routine for the memory system 210-a, for the host system 205-a, or for the system 200-a; on a periodic basis; or in response to a trigger event (e.g., a update for the memory system 210-a).

In response to the first request, the memory system 210-a may generate a first certificate. Thus, in at least some cases, the memory system 210-a may include an embedded certificate authority or otherwise be configured to self-generate and self-sign certificates related to an authenticity (e.g., verifiable identify, provenance, or both) of the memory system 210-a. The first certificate may include a public key, a first signature, and an indication of the characteristic of the memory system 210-a. In some examples, the memory system 210-a may generate the first signature using a first private key. The first private key may be stored at the memory system 210-a and may correspond to the public key. That is, the first private key and the public key may form a key pair. Upon generating the first certificate, the memory system 210-a may provide the first certificate to the host system 205-a.

In some examples, upon receiving the first certificate, the host system 205-a may verify the signature is endorsed by the memory system 210-a using the public key included in the first certificate (e.g., verify that the memory system 210-a has the private key that was used to generate the first signature in the first certificate). Additionally or alternatively, the host system 205-a may challenge the memory system 210-a to ensure that the memory system 210-a has the first private key used to generate the first certificate. In one example, the host system 205-a may transmit signaling to the memory system 210-a indicating a nonce (e.g., random number). The memory system 210-a may sign the nonce using the private key stored at the memory system 210-a. If the host system 205-a is able to verify the nonce using the public key included in the first certificate, the host system 205-a may ensure that the memory system 210-a has the first private key used to generate the first certificate. In some examples, if the host system 205-a successfully verifies the signature included in the first certificate or the memory system 210-a has the first private key, the host system 205-a may transmit a verification request to the server 215-a (e.g., to verify that the first certificate is trusted, which may mean that the memory system 210-a is endorsed by the manufacturer associated with the server 215-a). The host system 205-a may transmit the first certificate to the server 215-a (e.g., as part of or in connection with transmitting the verification request to the server 215-a). Additionally or alternatively, the first certificate may have been previously provided to the server 215-a. In some examples, the host system 205-a may identify that the characteristic indicated by the first certificate is an updated version of a characteristic indicated by a prior certificate received from the memory system 210-a and transmit the first certificate to the server 215-a in response to identifying that the characteristic is the updated version.

In response to receiving the first certificate, the server 215-a may identify the characteristic of the memory system 210-a indicated in the first certificate and compare the characteristic of the memory system 210-a to the set of characteristics stored at the server 215-a. If the characteristic matches one of the characteristics included in the set of characteristics (e.g., if the characteristic is a manufacturer-approved or otherwise valid characteristic for the memory system 210-a to have), the server 215-a may generate a second certificate. In some examples, the server 215-a may perform a two-step verification procedure. That is, the server 215-a may first verify the provenance of the memory system 210-a by verifying that the first signature is endorsed by the memory system 210-a using the public key included in the first certificate, and also by comparing the characteristic of the memory system 210-a indicated by the first certificate to the set of characteristics stored at the server 215-a. Additionally or alternatively, the server 215-a may generate a certificate based on information the server 215-a has on the memory system 210-a and compare the certificate to the first certificate to verify that the memory system 210-a generated the first certificate. In some examples, the server 215-a may have access to the same private key and public key stored at the memory system 210-a. The server 215-a may generate a certificate using the private key and public key pair and compare the certificate to the first certificate. If the certificate matches the first certificate, the server 215-a may verify the memory system 210-a generated the first certificate and generate the second certificate.

The second certificate may include the public key (that is, the same public key included in the first certificate) and a second signature. In some examples, the server 215-a may generate the second signature using a second private key. The second private key may be stored at the server 215-a as well as the host system 205. In some cases the second certificate may further include information that allows a recipient of the second certificate to obtain a second public key, which may form a key pair with the second private key. As one example, the second certificate may reference a third certificate that includes the second public key. In such example, the third certificate may be referred to as the root certificate. In another example, the third certificate may not include the second public key but may reference a fourth certificate. That is, certificates may be chained together, where the end of the chain is the root certificate containing the second public key. Upon generating the second certificate, the server 215-a may transmit the second certificate to the host system 205-a. In some examples, the host system 205-a may receive the second certificate from the server 215-a and relay (e.g., or transmit) the second certificate to the memory system 210-a, which may store the second certificate (e.g., for later retrieval by the host system 205).

Upon receiving the second certificate for the memory system 210-a, the host system 205-a may verify whether the memory system 210-a is endorsed by the server 215-a (e.g., endorsed by a certificate authority associated with the server 215-a, which may be associated with a purported manufacturer of the memory system 210). For example, the host system 205-a may verify the second signature included in the second certificate (e.g., using the second public key included in the second certificate). In some cases, the host system 205-a may additionally compare the public key for the memory system 210-a as indicated by the first certificate to the public key for the memory system 210-a as indicated by the second certificate, to confirm they match. For example, if the characteristic of the memory system 210-a is changed (e.g., updated), the public key of the memory system 210-a may also change. As such, if the public keys of the first certificate and the second certificate match, the host system 205-a may confirm that the memory system 210-a has not undergone any further updates since the start of the verification process. Additionally, using this method, the host system 205-a may validate that the second certificate is in fact associated with the memory system 210-a. However, in some examples, the host system 205-a may not receive the first certificate. In such case, the host system 205-a may retrieve the public key from the memory system 210-a after generating the second certificate and compare the retrieved public key to the public key included in the second certificate. In some cases, the host system 205-a may further utilize the memory system 210-a if the first signature of the first certificate is successfully verified, if the second signature of the second certificate is successfully verified, and if the first and second certificates indicate the same public key for the memory system 210-a, or any combination thereof. Otherwise, the host system 205 may refrain from further utilizing the memory system 210-a. The comparison of public keys for the memory system 210-a as indicated by the first and second certificates may, however, not occur or be factor in whether the host system 205-a further utilizes the memory system 210-a in some examples.

In some cases, the server 215-a may (e.g., over the course of time) generate many second certificates for many memory systems 210-a. In some cases, the server 215 may support batch-provisioning (e.g., of a plurality of second certificates) for different memory systems 210 (e.g., to another server or other entity, such as a manufacturer of systems 200, which may wish to authenticate a large batch of memory systems 210.

In some cases, there may be more than one certificate for a single memory system 210-a. For example, for a single memory system 210, the server 215 may generate a set of certificates, where each certificate of the set corresponds to a different characteristic of the set of characteristics stored at the server 215-a. That is, each certificate of the set may include a unique public key corresponding to the different possible characteristics of the respective memory system 210-a and a signature generated using a private key stored at the server 215-a.

In some examples, each time the characteristic of the memory system 210-a subject to a first certificate is updated (e.g., each time a firmware update occurs), the memory system 210-a may generate an updated first certificate (e.g., in response to the characteristic update itself or in response to a request from the host system 205-a that is received by the memory system 210-a after the characteristic update), which may include an updated public key for the memory system 210-a and an indication of the updated characteristic. Based on the updated first certificate, the server 215-a may generate a corresponding updated second certificate (e.g., in like fashion as how the server 215-a generated the prior second certificate), and the host system 205-a may authenticate the memory system 210-a and the updated characteristic based on the updated second certificate.

In the example of a system 200-b, a customer server 220 may transmit signaling to the server 215-b requesting endorsed certificates for one or more device characteristics of the memory system 210-b. As one example, the customer server 220 may request an endorsed certificate for a first device characteristic and a second device characteristic. The server 215-a may verify that the first device characteristic and the second device characteristic match a device characteristic of the set of device characteristics stored at the server 215-a. Upon verification, the server 215-a may generate a certificate for each requested device characteristic. Each certificate may include a public key (e.g., public key stored at the memory system 210-b), a signature generated based on a private key stored at the server 215-b, and an indication of a second public key corresponding to the private key. Receiving an endorsed certificate from the server 215-b may allow the customer server 220 may to verify that the associated device characteristic is valid.

The customer server 220 may then receive a second certificate from the memory system 210-b. The second certificate may include a characteristic associated with the memory device, the public key, and a signature generated using a second private key stored at the memory system 210-b. The customer server 220 may compare the contents of the certificates received from the server 215-b to the second certificate. If the characteristic included in the second certificate matches one of the characteristics associated with the certificates received from the server 215-a or if the public key of the certificates received from the server 215-b matches the public key included in the second certificate, the customer server 220 may verify the provenance of the memory system 210-a.

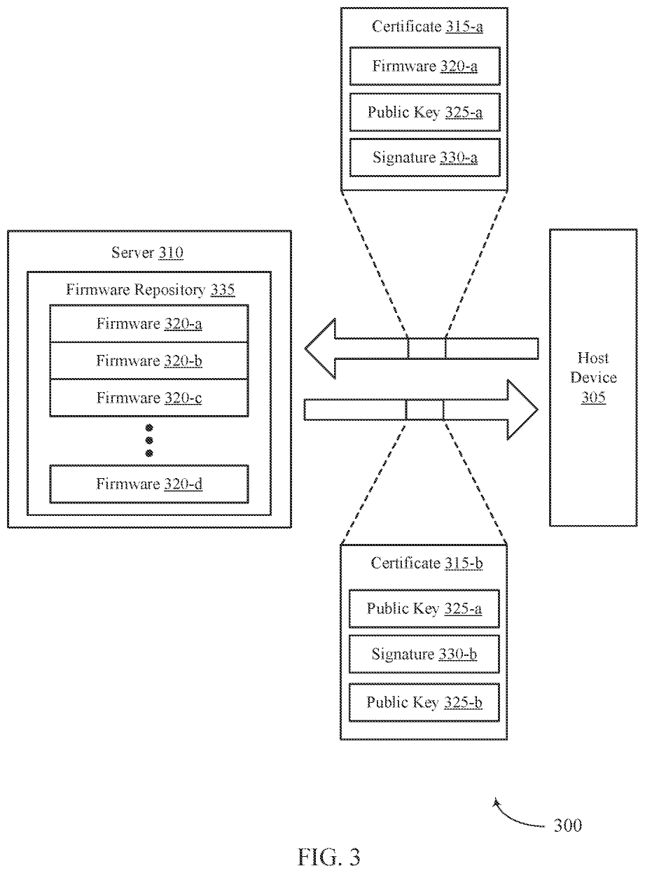

FIG. 3 illustrates an example of a system 300 that supports remote provisioning of certificates for memory system provenance in accordance with examples as disclosed herein. In some examples, the system 300 may implement aspects of a system 200. For example, the system 300 may include a server 310 and host device 305 which may be examples of a server 215 (e.g., server 215-a, server 215-b) and a host system 205-a as described in FIG. 2A and/or FIG. 2B. As described herein, a host system may perform a verification procedure to verify that a memory system originated from a trusted manufacturer, potentially along with one or more current characteristics of the memory system. In the example of FIG. 3, the characteristic may be a hash value corresponding to (e.g., based on some or all the content of) firmware 320 for operating the memory system, but other types of characteristics are possible as described herein.

The memory system may generate a certificate 315-a and provide the certificate 315-a to the host device 305. The certificate 315-a may include a public key 325-a, a signature 330-a, and an indication of firmware 320-a. The indication of firmware 320-a may be a firmware image associated with the memory system at the time that the first certificate is generated, or a hash thereof (or of a portion thereof). The memory system may generate the signature 330-a using a private key corresponding to the public key 325-a, where the private key is stored at the memory system. In examples, the private key may act as a certificate authority for the memory system (e.g., the private key may act as or be associated with an embedded certificate authority within the memory system).

Upon obtaining the certificate 315-a, the host device 305 may transmit the certificate 315-a to the server 310. In some examples, the server 310 may include a firmware repository 335. The firmware repository 335 may include multiple indications of firmware 320 (e.g., multiple firmware images or hashes thereof (or of portions thereof)). For example, the firmware repository 335 may include an indication of firmware 320-a, firmware 320-b, firmware 320-c, and firmware 320-d. The firmware 320 indicated in the firmware repository 335 may be different versions of firmware 320 that the memory system may be considered valid by the trusted manufacturer, such as different versions that the manufacturer may develop over time. As such, the versions of firmware 320 indicated in the firmware repository 335 may be firmware 320 may be deemed as good or trusted firmware (e.g., as opposed firmware that may be created or modified by a malicious actor).

Upon receiving the certificate 315-a, the server 330 may verify that the memory system and the associated firmware 320-a came from the manufacturer. For example, the server 310 may verify the signature 330-a using the public key 325-a provided in the certificate 315-a. If the server 310 is able to verify the signature 330-a using the public key 325-a, the server 310 may verify that firmware 320-a is verifiable back to the manufacturer. In one example, the server 310 may compare the firmware 320-a to the different versions of firmware 320 included in the firmware repository 335. If the firmware 320-a matches one of the versions of firmware 320 included in the firmware repository 335, the server 330 may ensure that firmware 320-a is verifiable back to the manufacturer. In the example of FIG. 3, the signature 330-a is successfully verified by the server 310, and the firmware 320-a indicated in the certificate 315-a matches firmware 320-a indicated in the firmware repository 335, so the server 310 may verify that the memory system and the associated firmware 320-a came from the manufacturer.

After verifying the memory system provenance, the server 310 may generate a certificate 315-b. The certificate 315-b may also include the public key 325-a, along with a signature 330-b and a second public key 325-b. In some cases, the certificate 315-b may also include an indication of the firmware 320-a. The signature 330-b may be generated using a private key corresponding to the second public key 325-b, where the private key is stored at the server 310. In some examples, the private key at the server 310 may act as a second certificate authority (e.g., associated with the manufacturer). The server 310 may, in some examples, transmit the certificate 315-b to the host device 305 and the host device 305 may transmit the certificate 315-b to the host system such that the host system may verify the provenance of the memory system. Using the methods as described herein may allow a host device to verify that a memory system originated from the trusted manufacturer as well as verify that the characteristic (e.g., firmware 320-a) of the memory system is supported by the trusted manufacturer.

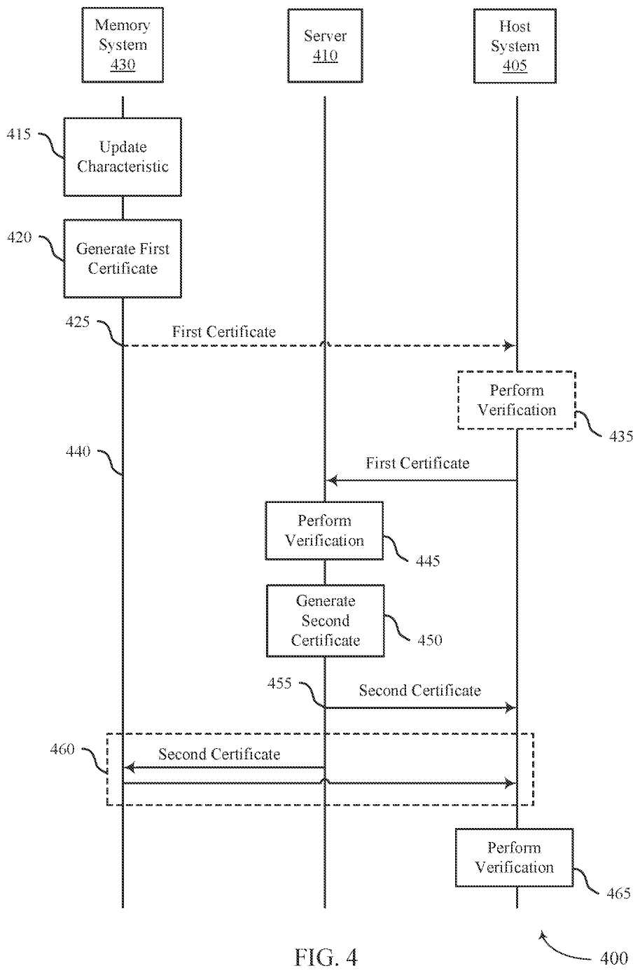

FIG. 4 illustrates an example of a process flow 400 that supports remote provisioning of certificates for memory system provenance in accordance with examples as disclosed herein. In some examples, the process flow 400 may be implemented by aspects of a system 100, a system 200, and a system 300. For examples, the process flow 400 may be implemented by a host system 405, a memory system 430, and a server 410 which may be examples of a host system 205 (e.g., host system 205-a), a server 215 (e.g., server 215-a, server 215-b), and a memory system 210 (e.g., memory system 210-a, memory system 210-b) as described in FIG. 2A and FIG. 2B. Alternative aspects of the following may be implemented, where some steps are performed in a different order then described or are not performed at all. In some cases, steps may include additional features not mentioned below, or further steps may be added.

At 415, the memory system 430 may update a characteristic associated with the memory system 430. In some cases, updating the characteristic associated with the memory system 430 may cause the public key and private key pair stored at the memory system 430 to change (e.g., the memory system 430 may update the key pair). In some examples, the memory system 430 may create a record to highlight a path from the old key pair to the new key pair. In some examples, the characteristic of the memory system 430 may be updated by the manufacturer. Alternatively, the characteristic of the memory system 430 may be updated by a malicious device. An example of the characteristic of the memory system 430 may be firmware or software for operating the memory system 430 or a system that includes the memory system 430.

In some examples, the host system 405 may transmit a first request to the memory system 430 to authenticate the memory system 430, such as to verify that the memory system 430 is endorsed by a certificate authority (e.g., certificate authority corresponding to the manufacturer).

At 420, the memory system 430 may generate a first certificate. The first certificate may include a first public key that corresponds to a first private key stored at the memory system 430, a first signature generated using the first private key, and an indication of the characteristic associated with the memory system 430. In some examples, the memory system 430 may generate the first certificate in response to updating the characteristic associated with the memory system 430. In another example, the memory system 430 may generate the first certificate in response to receiving the first request. At 425, the memory system 430 may potentially transmit the first certificate to the host system 405.

In some examples, the memory system 430 may store a public key and private key pair for each layer for a set of layers. A layer may represent authorities that measures and attest to higher layers. As an example, layer zero (e.g., lowest layer) may measure layer one code and create a certificate that indicates the layer one code. Layer zero may pass control to layer one and layer one may be unable to modify the code indicated in the certificate. That is, the layer one code is set by layer zero. For each layer of the set, the memory system 430 may create the first certificate using the associated public key and private key pair.

At 435, the host system 405 may perform a verification procedure. That is, the host system 405 may verify that the first signature included in the first certificate is endorsed by the memory system 430 using the first public key included in the first certificate. The host system 405 may still desire to verify that the first certificate can be trusted—e.g., that the memory system 430, including the characteristic as reflected in the first certificate, is endorsed by the trusted manufacturer. As such, upon performing the verification procedure at 435, the host system 405 may transmit a second request to verify that the characteristics of the memory system 430 is supported or endorsed by the certificate authority. In some examples, the host system 405 may identify that the characteristic is an updated version of a characteristic previously associated with the memory device (e.g., by comparing the first public to previously received public keys) and transmit the second request in response to the identifying.

At 440, the host system 405 may transmit the first certificate to a server 410. The server 410 may be an example of a cloud server and may be own or operated by the certificate authority (e.g., associated with the trusted manufacturer). In some examples, the server 410 may store a set of characteristics associated with the memory system 430. The set of characteristics may include known good characteristics. That is, the set of characteristics may include different versions of the characteristic that the memory system 430 may encounter after a being updated by the trusted manufacturer.

At 445, upon receiving the first certificate, the server 410 may perform a verification procedure. In some examples, the verification procedure may include two steps. For example, first, the server 410 may verify that the signature included in the first certificate is endorsed by the memory system 430 using the first public key. In some cases, the server 410 may additionally verify the characteristic included in the first certificate. The server 410 may compare the characteristic included in the first certificate to the set of characteristics. If the characteristic included in the first certificate matches one of the characteristics in the set of characteristics, the server 410 may verify the characteristic. In some examples, the server 410 may perform the verification procedure at 445 in response to identifying that the characteristic is an updated version of a characteristic previously associated with the memory device.

At 450, the server 410 may generate a second certificate. The second certificate may include a second public key corresponding to a second private key stored at the server 410 and a second signature generated using the second private key. The second certificate may also include the first public key that was also included in the first certificate. In some examples, the server may generate multiple certificate, where each certificate includes a unique public key corresponding to a private key that is associated with a respective memory device of a set of memory devices and a signature generated using the unique private key and a store the multiple certificates at the server 410. That is, the server 410 may support batch downloading from the server 410 of multiple certificates for multiple, different memory system 430.

In the case that the memory system 430 generates a first certificate for each layer of a set of layers, the server 410 may generate a single second certificate for more than one layer of the set of layers. For example, the server 410 may generate a single second certificate for layer one and layer zero (e.g., if layer one code is a function of layer zero code). In another example, server 410 may generate a second certificate for each layer of the set of layers.

The server 410 may transmit the second certificate to the host system 405. For example, at 455, the server 410 may transmit the second certificate directly to the host system 405. Alternatively, at 460, the server 410 may transmit the second certificate to the memory system 430 (using the host system 405 as a relay), and the memory system 430 may store the second certificate and later transmit the second certificate to the host system 405 upon request by the host system 405. In some examples, the server 410 may store the second certificate for a duration before transmitting the second certificate. For example, the server 410 may receive a third request from the host system 405 to verify that the characteristics associated with the memory device are endorsed by the certificate authority and store the second certificate for a duration between generating the second certificate and receiving the third request.

At 465, the host system 405 may perform a verification procedure. For example, the host system 405 may verify that the second signature included in the second certificate is endorsed by the certificate authority using the second public key. In some examples, the host system 405 may determine that the first public key included in the first certificate is also included in the second certificate. If the first public key included in the first certificate is also included in the second certificate, the memory system 430 may verify that the second certificate is associated with the memory system 430 and that the characteristic of the memory system 430 has not been updated between 435 and 465. Based on the verification procedure at 465 indicating that the memory system 430 is endorse by the certificate authority associated with the server 410, the host system 405 may then utilize the memory system 430.

FIG. 5 shows a block diagram 500 of a server 520 that supports remote provisioning of certificates for memory system provenance in accordance with examples as disclosed herein. The server 520 may be an example of aspects of a server as described with reference to FIGS. 1 through 4. The server 520, or various components thereof, may be an example of means for performing various aspects of remote provisioning of certificates for memory system provenance as described herein. For example, the server 520 may include a server certificate receiver 525, a server verification component 530, a server certificate generator 535, a server certificate transmitter 540, a server characteristics component 545, a server request component 550, a server certificate generator 555, or any combination thereof. Each of these components may communicate, directly or indirectly, with one another (e.g., via one or more buses).

The server certificate receiver 525 may be configured as or otherwise support a means for receiving a first certificate comprising a first public key that corresponds to a first private key of a memory system, a first signature generated based on the first private key of the memory system, and an indication of a characteristic of the memory system. The server verification component 530 may be configured as or otherwise support a means for verifying, using the first public key, whether the first signature included in the first certificate is endorsed by a certificate authority associated with the first private key of the memory system. The server verification component 530 may be configured as or otherwise support a means for verifying whether the characteristic of the memory system is included in a set of characteristics stored at the server. The server certificate generator 535 may be configured as or otherwise support a means for generating, based on verifying that the first signature included in the first certificate is endorsed by the certificate authority associated with the first private key and that the characteristic of the memory system is included in the set of characteristics stored at the server, a second certificate that comprises the first public key and a second signature, the second signature generated based on a second private key stored at the server. The server certificate transmitter 540 may be configured as or otherwise support a means for transmitting (e.g., to at least one of the host device or the memory device) the second certificate.

In some examples, the server verification component 530 may be configured as or otherwise support a means for identifying that the characteristic of the memory system is an updated version of a prior characteristic of the memory system, where verifying that the characteristic of the memory system is included in the set of characteristics stored at the server is based on identifying that the characteristic is the updated version of the prior characteristic.

In some examples, to support verifying that the characteristic of the memory system is included in the set of characteristics stored at the server, the server characteristics component 545 may be configured as or otherwise support a means for determining that the characteristic of the memory system matches a characteristic included in the set of characteristics stored at the server.

In some examples, the server request component 550 may be configured as or otherwise support a means for receiving a request to verify that the memory system is endorsed by a second certificate authority associated with the second private key stored at the server, where transmitting the second certificate is based on receiving the request to verify that the memory system is endorsed by the second certificate authority.

In some examples, the server certificate transmitter 540 may be configured as or otherwise support a means for storing the second certificate for a duration between generating the second certificate and receiving the request to verify that the memory system is endorsed by the second certificate authority.

In some examples, the server certificate generator 555 may be configured as or otherwise support a means for a set of certificates, where each certificate of the set comprises a unique public key corresponding to a unique private key that is associated with a respective memory system of a set of memory systems and further comprises a signature generated based on the second private key stored at the server. In some examples, the server certificate generator 555 may be configured as or otherwise support a means for storing the set of certificates at the server.

In some examples, the server request component 550 may be configured as or otherwise support a means for receiving a request for two or more certificates of the set of certificates. In some examples, the server certificate transmitter 540 may be configured as or otherwise support a means for transmitting the two or more requested certificates in response to the request.

In some examples, the set of characteristics comprises characteristics that have been validated by the server. In some examples, the characteristic of the memory system comprises or is based on a characteristic of one or more hardware components of the memory system, a characteristic of firmware or software for operating the memory system or a system that includes the memory system, or any combination thereof. In some examples, the characteristic of the memory system comprises a hash value generated based on the characteristic of one or more hardware components of the memory system, the characteristic of firmware or software for operating the memory system or the system that includes the memory system, or any combination thereof.

In some examples, the second private key stored at the server is associated with a manufacturer of the memory system. In some examples, the second certificate further comprises information associated with a second public key corresponding to the second private key, a second indication of the characteristic of the memory system, or both.

In some examples, the server certificate receiver 525 may be configured as or otherwise support a means for receiving a third certificate comprising a third public key that corresponds to a third private key of the memory system, a third signature generated based on the third private key of the memory system, and an indication of an updated characteristic of the memory system. In some examples, the server verification component 530 may be configured as or otherwise support a means for verifying, using the third public key, whether the third signature included in the third certificate is endorsed by the certificate authority associated with the third private key of the memory system. In some examples, the server verification component 530 may be configured as or otherwise support a means for verifying whether the updated characteristic associated with the memory system is included in the set of characteristics or an updated set of characteristics stored at the server. In some examples, the server certificate generator 555 may be configured as or otherwise support a means for generating, based on verifying that the third signature included in the third certificate is endorsed by the certificate authority associated with the first private key and that the updated characteristic of the memory system is included in the set of characteristics or the updated set of characteristics stored at the server, a fourth certificate that comprises the third public key and a fourth signature, the fourth signature generated based on the second private key stored at the server.

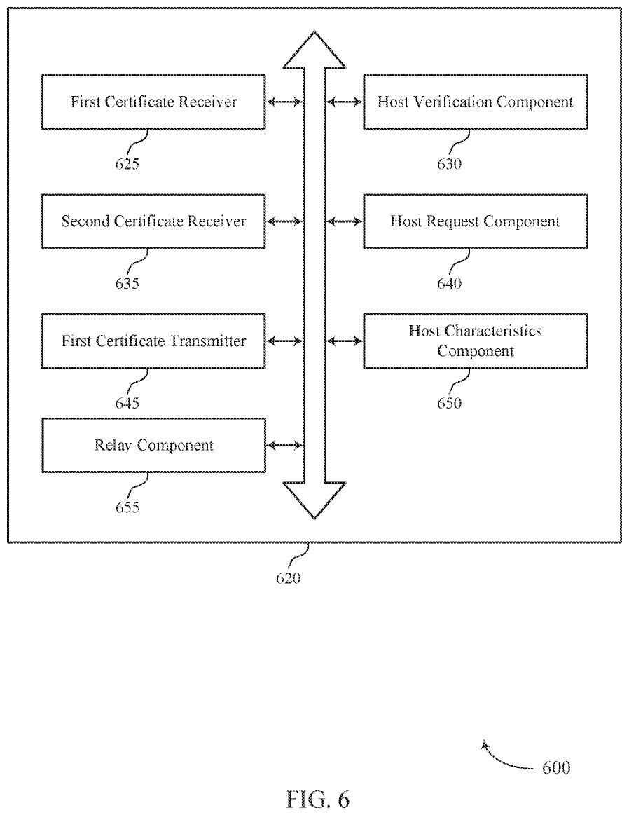

FIG. 6 shows a block diagram 600 of a host system 620 that supports remote provisioning of certificates for memory system provenance in accordance with examples as disclosed herein. The host system 620 may be an example of aspects of a host system as described with reference to FIGS. 1 through 4. The host system 620, or various components thereof, may be an example of means for performing various aspects of remote provisioning of certificates for memory system provenance as described herein. For example, the host system 620 may include a first certificate receiver 625, a host verification component 630, a second certificate receiver 635, a host request component 640, a first certificate transmitter 645, a host characteristics component 650, a relay component 655, or any combination thereof. Each of these components may communicate, directly or indirectly, with one another (e.g., via one or more buses).

The first certificate receiver 625 may be configured as or otherwise support a means for receiving a first certificate from the memory system, where the first certificate comprises a first public key that corresponds to a first private key of the memory system and a first signature generated based on the first private key. The host verification component 630 may be configured as or otherwise support a means for verifying, using the first public key, whether the first signature included in the first certificate is endorsed by a certificate authority associated with the first private key of the memory system. The second certificate receiver 635 may be configured as or otherwise support a means for receiving a second certificate from the memory system or a server, where the second certificate comprises a second public key and a second signature generated based on a second private key of the server. In some examples, the host verification component 630 may be configured as or otherwise support a means for verifying whether the second signature is endorsed by a second certificate authority associated with the second private key.

In some examples, the host verification component 630 may be configured as or otherwise support a means for verifying whether the second public key included in the second certificate matches the first public key included in the first certificate. In some examples, the host verification component 630 may be configured as or otherwise support a means for verifying that the memory system possesses the first private key based on verifying that the second public key matches the first public key. In some examples, the host verification component 630 may be configured as or otherwise support a means for verifying that the second certificate is associated with the memory system based on verifying that the second public key matches the first public key.

In some examples, the host request component 640 may be configured as or otherwise support a means for transmitting, to the memory system or the server, a request for the second certificate based on verifying that the first signature is endorsed by the memory system, where receiving the second certificate is based on transmitting the request.

In some examples, the first certificate transmitter 645 may be configured as or otherwise support a means for transmitting the first certificate to the server, where receiving the second certificate is from the server and is based on transmitting the first certificate to the server.

In some examples, the first certificate further includes an indication of a characteristic of the memory system. In some examples, the characteristic of the memory system comprises or is based on a characteristic of one or more hardware components of the memory system, a characteristic of firmware or software for operating the memory system or a system that includes the memory system, or any combination thereof.

In some examples, the host characteristics component 650 may be configured as or otherwise support a means for identifying that the characteristic associated with the memory system is an updated version of a characteristic previously associated with the memory system, where receiving the second certificate is based on identifying that the characteristic associated with the memory system is the updated version.

In some examples, the second certificate further comprises a second indication of the characteristic of the memory system. In some examples, the second certificate further comprises information associated with a second public key corresponding to the second private key, and where the controller is configured to cause the host system to use the second public key included in the second certificate to verify whether the second signature is endorsed by the second certificate authority associated with the second private key.

In some examples, the host characteristics component 650 may be configured as or otherwise support a means for determining that the first public key included in the first certificate is different from another public key included in another certificate previously received from the memory system, where receiving the second certificate is based on determining that the first public key included in the first certificate is different from the other public key.

In some examples, the relay component 650 may be configured as or otherwise support a means for relaying signaling between the memory system and the server.

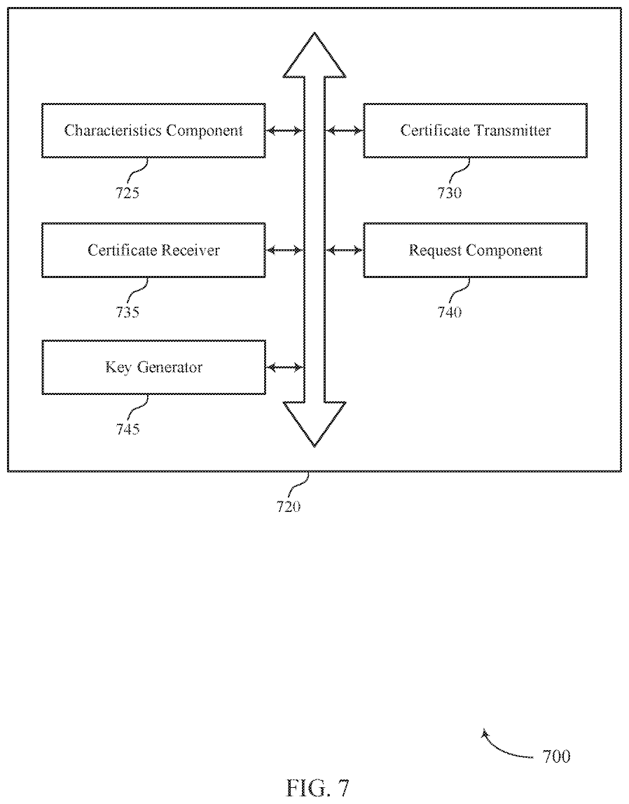

FIG. 7 shows a block diagram 700 of a memory system 720 that supports remote provisioning of certificates for memory system provenance in accordance with examples as disclosed herein. The memory system 720 may be an example of aspects of a memory system as described with reference to FIGS. 1 through 4. The memory system 720, or various components thereof, may be an example of means for performing various aspects of remote provisioning of certificates for memory system provenance as described herein. For example, the memory system 720 may include a characteristics component 725, a certificate transmitter 730, a certificate receiver 735, a request component 740, a key generator 745, or any combination thereof. Each of these components may communicate, directly or indirectly, with one another (e.g., via one or more buses).

The characteristics component 725 may be configured as or otherwise support a means for updating, at the memory system, a characteristic of the memory system. The certificate transmitter 730 may be configured as or otherwise support a means for transmitting, by the memory system, a first certificate to a server based on updating the characteristic of the memory system, where the first certificate comprises a first public key that corresponds to a first private key stored at the memory system, a signature generated based on the first private key, and an indication of the updated characteristic of the memory system.

In some examples, the certificate receiver 735 may be configured as or otherwise support a means for receiving a second certificate from the server, where the second certificate comprises the first public key and a second signature generated based on a second private key of the server. In some examples, the certificate transmitter 730 may be configured as or otherwise support a means for transmitting the second certificate to a host device for the memory system. In some examples, the second certificate further comprises a second public key that corresponds to the second private key.

In some examples, the certificate transmitter 730 may be configured as or otherwise support a means for transmitting the first certificate to a host device for the memory system.

In some examples, the request component 740 may be configured as or otherwise support a means for receiving, from the host device, a request to verify that the memory system is endorsed by a certificate authority associated with the server, where transmitting the first certificate to the server is based on receiving the request.

In some examples, the updated characteristic of the memory system comprises or is based on a characteristic of one or more hardware components of the memory system, a characteristic of firmware or software for operating the memory system or a system that includes the memory system, or any combination thereof.

In some examples, the key generator 745 may be configured as or otherwise support a means for generating the first public key based on the characteristics component 725 updating the characteristic associated with the memory system.

In some examples, the characteristics component 725 may be configured as or otherwise support a means for further updating, at the memory system, the characteristic of the memory system. The certificate transmitter 730 may be configured as or otherwise support a means for transmitting, by the memory system, a third certificate to the server based on further updating the characteristic of the memory system, where the third certificate comprises another public key that corresponds to another private key stored at the memory system, another signature generated based on the other private key, and an indication of the further updated characteristic of the memory system.

In some examples, the certificate receiver 735 and the certificate transmitter 730 may be configured as or otherwise support a means for using a host device for the memory system as a relay to receive signaling from or transmit signaling to the server

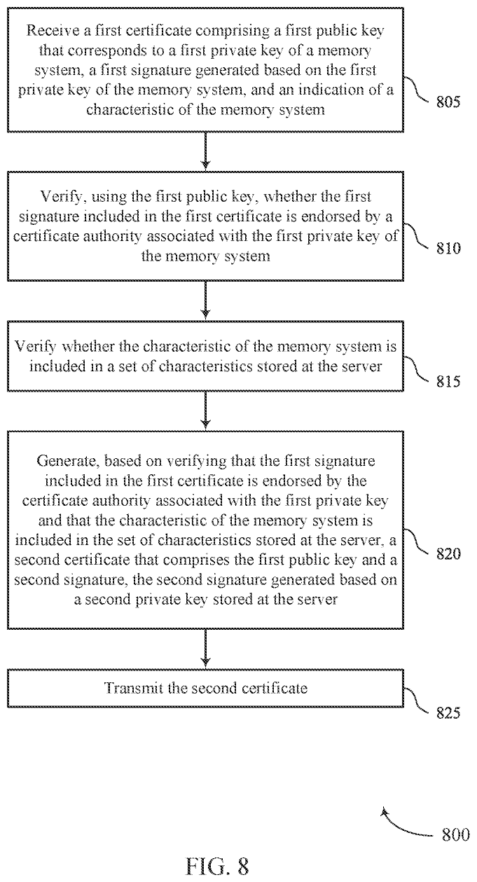

FIG. 8 shows a flowchart illustrating a method 800 that supports remote provisioning of certificates for memory system provenance in accordance with examples as disclosed herein. The operations of method 800 may be implemented by a server or its components as described herein. For example, the operations of method 800 may be performed by a server as described with reference to FIGS. 1 through 5. In some examples, a server may execute a set of instructions to control the functional elements of the device to perform the described functions. Additionally, or alternatively, the server may perform aspects of the described functions using special-purpose hardware.

At 805, the method may include receiving a first certificate comprising a first public key that corresponds to a first private key of a memory system, a first signature generated based on the first private key of the memory system, and an indication of a characteristic of the memory system. The operations of 805 may be performed in accordance with examples as disclosed herein. In some examples, aspects of the operations of 805 may be performed by a server certificate receiver 525 as described with reference to FIG. 5.

At 810, the method may include verifying, using the first public key, whether the first signature included in the first certificate is endorsed by a certificate authority associated with the first private key of the memory system. The operations of 810 may be performed in accordance with examples as disclosed herein. In some examples, aspects of the operations of 810 may be performed by a server verification component 530 as described with reference to FIG. 5.

At 815, the method may include verifying whether the characteristic of the memory system is included in a set of characteristics stored at the server. The operations of 815 may be performed in accordance with examples as disclosed herein. In some examples, aspects of the operations of 815 may be performed by a server verification component 530 as described with reference to FIG. 5.

At 820, the method may include generating, based on verifying that the first signature included in the first certificate is endorsed by the certificate authority associated with the first private key and that the characteristic of the memory system is included in the set of characteristics stored at the server, a second certificate that comprises the first public key and a second signature, the second signature generated based on a second private key stored at the server. The operations of 820 may be performed in accordance with examples as disclosed herein. In some examples, aspects of the operations of 820 may be performed by a server certificate generator 535 as described with reference to FIG. 5.

At 825, the method may include transmitting the second certificate. The operations of 825 may be performed in accordance with examples as disclosed herein. In some examples, aspects of the operations of 825 may be performed by a server certificate transmitter 540 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a first certificate comprising a first public key that corresponds to a first private key of a memory system, a first signature generated based on the first private key of the memory system, and an indication of a characteristic of the memory system; verifying, using the first public key, whether the first signature included in the first certificate is endorsed by a certificate authority associated with the first private key of the memory system; verifying whether the characteristic of the memory system is included in a set of characteristics stored at the apparatus; generating, based on verifying that the first signature included in the first certificate is endorsed by the certificate authority associated with the first private key and that the characteristic of the memory system is included in the set of characteristics stored at the apparatus, a second certificate that comprises the first public key and a second signature, the second signature generated based on a second private key stored at the apparatus; and transmitting the second certificate.
Aspect 2: The method, apparatus, or non-transitory computer-readable medium of aspect 1, further including operations, features, circuitry, logic, means, or instructions, or any combination thereof for identifying that the characteristic of the memory system is an updated version of a prior characteristic of the memory system, where verifying that the characteristic of the memory system is included in the set of characteristics stored at the apparatus is based on identifying that the characteristic is the updated version of the prior characteristic.
Aspect 3: The method, apparatus, or non-transitory computer-readable medium of any of aspects 1 through 2, where operations, features, circuitry, logic, means, or instructions, or any combination thereof for verifying that the characteristic of the memory system is included in the set of characteristics stored at the apparatus includes operations, features, circuitry, logic, means, or instructions, or any combination thereof for determining that the characteristic of the memory system matches a characteristic included in the set of characteristics stored at the apparatus.
Aspect 4: The method, apparatus, or non-transitory computer-readable medium of any of aspects 1 through 3, further including operations, features, circuitry, logic, means, or instructions, or any combination thereof for receiving a request to verify that the memory system is endorsed by a second certificate authority associated with the second private key stored at the apparatus, where transmitting the second certificate is based on receiving the request to verify that the memory system is endorsed by the second certificate authority.
Aspect 5: The method, apparatus, or non-transitory computer-readable medium of any of aspects 1 through 4, further including operations, features, circuitry, logic, means, or instructions, or any combination thereof for storing the second certificate for a duration between generating the second certificate and receiving the request to verify that the memory system is endorsed by the second certificate authority.
Aspect 6: The method, apparatus, or non-transitory computer-readable medium of aspect 5, further including operations, features, circuitry, logic, means, or instructions, or any combination thereof for generating a plurality of certificates, where each certificate of the plurality comprises a unique public key corresponding to a unique private key that is associated with a respective memory system of a plurality of memory systems and further comprises a signature generated based on the second private key stored at the apparatus; and storing the plurality of certificates at the apparatus.
Aspect 7: The method, apparatus, or non-transitory computer-readable medium of any of aspects 1 through 6, further including operations, features, circuitry, logic, means, or instructions, or any combination thereof for receiving a request for two or more certificates of the plurality of certificates, and transmitting the two or more requested certificates in response to the request.
Aspect 8: The method, apparatus, or non-transitory computer-readable medium of any of aspects 1 through 7 where the set of characteristics comprises characteristics that have been validated by the apparatus.
Aspect 9: The method, apparatus, or non-transitory computer-readable medium of any of aspects 1 through 8 where the characteristic of the memory system comprises or is based on a characteristic of one or more hardware components of the memory system, a characteristic of firmware or software for operating the memory system or a system that includes the memory system, or any combination thereof.
Aspect 10: The method, apparatus, or non-transitory computer-readable medium of any of aspects 1 through 9 where the characteristic of the memory system comprises a hash value generated based on the characteristic of one or more hardware components of the memory system, the characteristic of firmware or software for operating the memory system or the system that includes the memory system, or any combination thereof.
Aspect 11: The method, apparatus, or non-transitory computer-readable medium of any of aspects 1 through 10 where the second private key stored at the apparatus is associated with a manufacturer of the memory system.
Aspect 12: The method, apparatus, or non-transitory computer-readable medium of any of aspects 1 through 11 where the second certificate further comprises information associated with a second public key corresponding to the second private key, a second indication of the characteristic of the memory system, or both.
Aspect 13: The method, apparatus, or non-transitory computer-readable medium of any of aspects 1 through 12, further including operations, features, circuitry, logic, means, or instructions, or any combination thereof for receiving a third certificate comprising a third public key that corresponds to a third private key of the memory system, a third signature generated based on the third private key of the memory system, and an indication of an updated characteristic of the memory system; verifying, using the third public key, whether the third signature included in the third certificate is endorsed by the certificate authority associated with the third private key of the memory system; verifying whether the updated characteristic associated with the memory system is included in the set of characteristics or an updated set of characteristics stored at the apparatus; and generating, based on verifying that the third signature included in the third certificate is endorsed by the certificate authority associated with the first private key and that the updated characteristic of the memory system is included in the set of characteristics or the updated set of characteristics stored at the apparatus, a fourth certificate that comprises the third public key and a fourth signature, the fourth signature generated based on the second private key stored at the apparatus

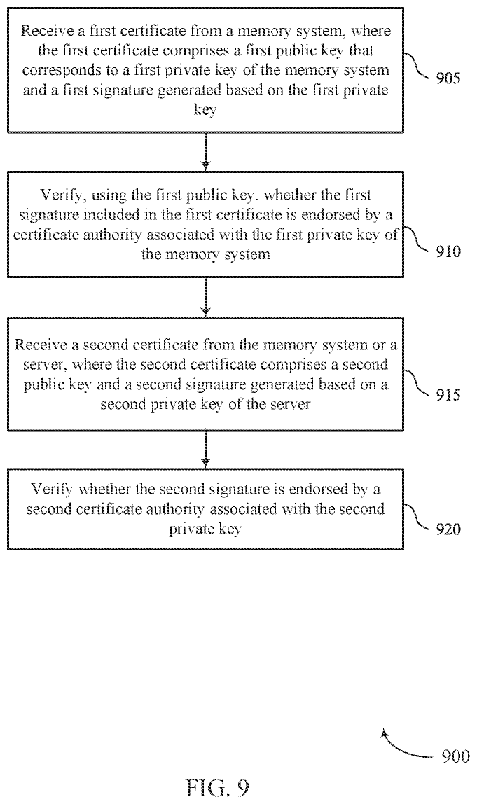

FIG. 9 shows a flowchart illustrating a method 900 that supports remote provisioning of certificates for memory system provenance in accordance with examples as disclosed herein. The operations of method 900 may be implemented by a host system or its components as described herein. For example, the operations of method 900 may be performed by a host system as described with reference to FIGS. 1 through 4 and 6. In some examples, a host system may execute a set of instructions to control the functional elements of the device to perform the described functions. Additionally, or alternatively, the host system may perform aspects of the described functions using special-purpose hardware.

At 905, the method may include receiving a first certificate from a memory system, where the first certificate comprises a first public key that corresponds to a first private key of the memory system and a first signature generated based on the first private key. The operations of 905 may be performed in accordance with examples as disclosed herein. In some examples, aspects of the operations of 905 may be performed by a first certificate receiver 625 as described with reference to FIG. 6.

At 910, the method may include verifying, using the first public key, whether the first signature included in the first certificate is endorsed by a certificate authority associated with the first private key of the memory system. The operations of 910 may be performed in accordance with examples as disclosed herein. In some examples, aspects of the operations of 910 may be performed by a host verification component 630 as described with reference to FIG. 6.

At 915, the method may include receiving a second certificate from the memory system or a server, where the second certificate comprises a second public key and a second signature generated based on a second private key of the server. The operations of 915 may be performed in accordance with examples as disclosed herein. In some examples, aspects of the operations of 915 may be performed by a second certificate receiver 635 as described with reference to FIG. 6.

At 920, the method may include verifying whether the second signature is endorsed by a second certificate authority associated with the second private key. The operations of 920 may be performed in accordance with examples as disclosed herein. In some examples, aspects of the operations of 920 may be performed by a host verification component 630 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:
Aspect 14: A method, apparatus, or non-transitory computer-readable medium including operations, features, circuitry, logic, means, or instructions, or any combination thereof for receiving a first certificate from the memory system, where the first certificate comprises a first public key that corresponds to a first private key of the memory system and a first signature generated based on the first private key; verifying, using the first public key, whether the first signature included in the first certificate is endorsed by a certificate authority associated with the first private key of the memory system; receiving a second certificate from the memory system or a server, where the second certificate comprises a second public key and a second signature generated based on a second private key of the server; and verifying whether the second signature is endorsed by a second certificate authority associated with the second private key.
Aspect 15: The method, apparatus, or non-transitory computer-readable medium of aspect 14, further including operations, features, circuitry, logic, means, or instructions, or any combination thereof for verifying whether the second public key included in the second certificate matches the first public key included in the first certificate.
Aspect 16: The method, apparatus, or non-transitory computer-readable medium of any of aspects 14 through 15, further including operations, features, circuitry, logic, means, or instructions, or any combination thereof for verifying that the memory system possesses the first private key based on verifying that the second public key matches the first public key.
Aspect 17: The method, apparatus, or non-transitory computer-readable medium of any of aspects 14 through 16, further including operations, features, circuitry, logic, means, or instructions, or any combination thereof for verifying that the second certificate is associated with the memory system based on verifying that the second public key matches the first public key.
Aspect 18: The method, apparatus, or non-transitory computer-readable medium of aspects 14 through 17, further including operations, features, circuitry, logic, means, or instructions, or any combination thereof for transmitting, to the memory system or the server, a request for the second certificate based on verifying that the first signature is endorsed by the memory system, where receiving the second certificate is based on transmitting the request.
Aspect 19: The method, apparatus, or non-transitory computer-readable medium of any of aspects 14 through 18, further including operations, features, circuitry, logic, means, or instructions, or any combination thereof for transmitting the first certificate to the server, where receiving the second certificate is from the server and is based on transmitting the first certificate to the server.
Aspect 20: The method, apparatus, or non-transitory computer-readable medium of any of aspects 14 through 19 where the first certificate further comprises an indication of a characteristic of the memory system.
Aspect 21: The method, apparatus, or non-transitory computer-readable medium of aspect 20 where the characteristic of the memory system comprises or is based on a characteristic of one or more hardware components of the memory system, a characteristic of firmware or software for operating the memory system or a system that includes the memory system, or any combination thereof.
Aspect 22: The method, apparatus, or non-transitory computer-readable medium of any of aspects 20 through 21, further including operations, features, circuitry, logic, means, or instructions, or any combination thereof for identifying that the characteristic associated with the memory system is an updated version of a characteristic previously associated with the memory system, where receiving the second certificate is based on identifying that the characteristic associated with the memory system is the updated version.
Aspect 23: The method, apparatus, or non-transitory computer-readable medium of aspects 20 through 22 where the second certificate further comprises a second indication of the characteristic of the memory system.
Aspect 24: The method, apparatus, or non-transitory computer-readable medium of any of aspects 14 through 23 where the second certificate further comprises information associated with a second public key corresponding to the second private key, and where the controller is configured to cause the apparatus to use the second public key included in the second certificate to verify whether the second signature is endorsed by the second certificate authority associated with the second private key.
Aspect 25: The method, apparatus, or non-transitory computer-readable medium of any of aspects 14 through 24, further including operations, features, circuitry, logic, means, or instructions, or any combination thereof for determining that the first public key included in the first certificate is different from another public key included in another certificate previously received from the memory system, where receiving the second certificate is based on determining that the first public key included in the first certificate is different from the other public key.
Aspect 26: The method, apparatus, or non-transitory computer-readable medium of any of aspects 14 through 28, further including operations, features, circuitry, logic, means, or instructions, or any combination thereof for relaying signaling between the memory system and the server.

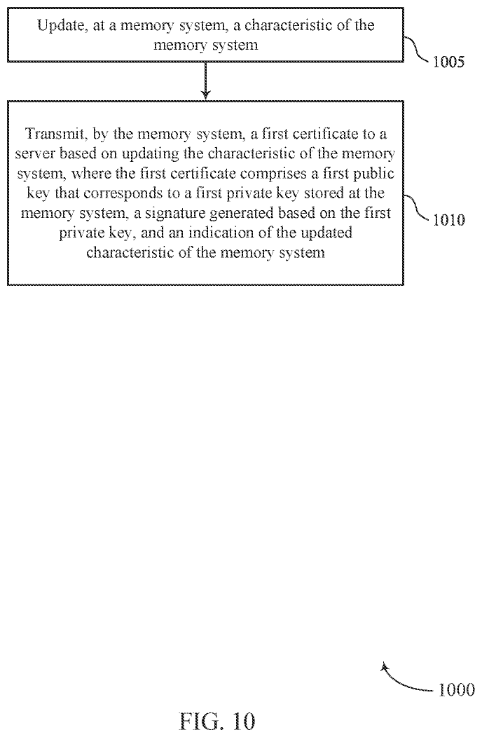

FIG. 10 shows a flowchart illustrating a method 1000 that supports remote provisioning of certificates for memory system provenance in accordance with examples as disclosed herein. The operations of method 1000 may be implemented by a memory system or its components as described herein. For example, the operations of method 1000 may be performed by a memory system as described with reference to FIGS. 1 through 4 and 7. In some examples, a memory system may execute a set of instructions to control the functional elements of the device to perform the described functions. Additionally, or alternatively, the memory system may perform aspects of the described functions using special-purpose hardware.

At 1005, the method may include updating, at the memory system, a characteristic of the memory system. The operations of 1005 may be performed in accordance with examples as disclosed herein. In some examples, aspects of the operations of 1005 may be performed by a characteristics component 725 as described with reference to FIG. 7.

At 1010, the method may include transmitting, by the memory system, a first certificate to a server based on updating the characteristic of the memory system, where the first certificate comprises a first public key that corresponds to a first private key stored at the memory system, a signature generated based on the first private key, and an indication of the updated characteristic of the memory system. The operations of 1010 may be performed in accordance with examples as disclosed herein. In some examples, aspects of the operations of 1010 may be performed by a certificate transmitter 730 as described with reference to FIG. 7.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:
Aspect 27: A method, apparatus, or non-transitory computer-readable medium including operations, features, circuitry, logic, means, or instructions, or any combination thereof for updating, at the memory system, a characteristic of the memory system; and transmitting, by the memory system, a first certificate to a server based on updating the characteristic of the memory system, where the first certificate comprises a first public key that corresponds to a first private key stored at the memory system, a signature generated based on the first private key, and an indication of the updated characteristic of the memory system.
Aspect 28: The method, apparatus, or non-transitory computer-readable medium of aspect 27, further including operations, features, circuitry, logic, means, or instructions, or any combination thereof for receiving a second certificate from the server, where the second certificate comprises the first public key and a second signature generated based on a second private key of the server; and transmitting the second certificate to a host device for the memory system.
Aspect 29: The method, apparatus, or non-transitory computer-readable medium of aspect 28 where the second certificate further comprises a second public key that corresponds to the second private key.
Aspect 30: The method, apparatus, or non-transitory computer-readable medium of any of aspects 27 through 29, further including operations, features, circuitry, logic, means, or instructions, or any combination thereof for transmitting the first certificate to a host device for the memory system.
Aspect 31: The method, apparatus, or non-transitory computer-readable medium of aspect 30, further including operations, features, circuitry, logic, means, or instructions, or any combination thereof for receiving, from the host device, a request to verify that the memory system is endorsed by a certificate authority associated with the server, where transmitting the first certificate to the server is based on receiving the request.
Aspect 32: The method, apparatus, or non-transitory computer-readable medium of any of aspects 27 through 31 where the server is operated or owned by a certificate authority that corresponds to a manufacturer of the memory device.
Aspect 33: The method, apparatus, or non-transitory computer-readable medium of any of aspects 27 through 32 where the updated characteristic of the memory system comprises or is based on a characteristic of one or more hardware components of the memory system, a characteristic of firmware or software for operating the memory system or a system that includes the memory system, or any combination thereof.
Aspect 34: The method, apparatus, or non-transitory computer-readable medium of any of aspects 27 through 33, further including operations, features, circuitry, logic, means, or instructions, or any combination thereof for further updating, at the memory system, the characteristic of the memory system; and transmitting, by the memory system, a third certificate to the server based on further updating the characteristic of the memory system, where the third certificate comprises another public key that corresponds to another private key stored at the memory system, another signature generated based on the other private key, and an indication of the further updated characteristic of the memory system.
Aspect 35: The method, apparatus, or non-transitory computer-readable medium of any of aspects 27 through 34 further including operations, features, circuitry, logic, means, or instructions, or any combination thereof for using a host device for the memory system as a relay to receive signaling from or transmit signaling to the server.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when.” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A. B. or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, w % bile discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
at least one processor; and
memory coupled with the at least one processor, the memory and the at least one processor configured to cause the apparatus to:
receive a first certificate comprising a first public key that corresponds to a first private key of a memory system, a first signature generated based at least in part on the first private key of the memory system, and an indication of a characteristic of the memory system;
verify, using the first public key, whether the first signature included in the first certificate is endorsed by a certificate authority associated with the first private key of the memory system;
verify whether the characteristic of the memory system is included in a set of characteristics stored at the apparatus;
generate, based at least in part on verifying that the first signature included in the first certificate is endorsed by the certificate authority associated with the first private key and that the characteristic of the memory system is included in the set of characteristics stored at the apparatus, a second certificate that comprises the first public key and a second signature, the second signature generated based at least in part on a second private key stored at the apparatus; and
transmit the second certificate.

2. The apparatus of claim 1, wherein the memory and the at least one processor are further configured to cause the apparatus to:
identify that the characteristic of the memory system is an updated version of a prior characteristic of the memory system, wherein verifying that the characteristic of the memory system is included in the set of characteristics stored at the apparatus is based at least in part on identifying that the characteristic is the updated version of the prior characteristic.

3. The apparatus of claim 1, wherein, to verify that the characteristic of the memory system is included in the set of characteristics stored at the apparatus, the memory and the at least one processor are configured to cause the apparatus to:
determine that the characteristic of the memory system matches a characteristic included in the set of characteristics stored at the apparatus.

4. The apparatus of claim 1, wherein the memory and the at least one processor are further configured to cause the apparatus to:
receive a request to verify that the memory system is endorsed by a second certificate authority associated with the second private key stored at the apparatus, wherein transmitting the second certificate is based at least in part on receiving the request to verify that the memory system is endorsed by the second certificate authority.

5. The apparatus of claim 4, wherein the memory and the at least one processor are further configured to cause the apparatus to:
store the second certificate for a duration between generating the second certificate and receiving the request to verify that the memory system is endorsed by the second certificate authority.

6. The apparatus of claim 1, wherein the memory and the at least one processor are further configured to cause the apparatus to:
generate a plurality of certificates, wherein each certificate of the plurality comprises a unique public key corresponding to a unique private key that is associated with a respective memory system of a plurality of memory systems and further comprises a signature generated based at least in part on the second private key stored at the apparatus; and
store the plurality of certificates at the apparatus.

7. The apparatus of claim 6, wherein memory and the at least one processor are further configured to cause the apparatus to:
receive a request for two or more certificates of the plurality of certificates; and
transmit the two or more requested certificates in response to the request.

8. The apparatus of claim 1, wherein the set of characteristics comprises characteristics that have been validated by the apparatus.

9. The apparatus of claim 1, wherein the characteristic of the memory system comprises or is based at least in part on a characteristic of one or more hardware components of the memory system, a characteristic of firmware or software for operating the memory system or a system that includes the memory system, or any combination thereof.

10. The apparatus of claim 9, wherein the characteristic of the memory system comprises a hash value generated based at least in part on the characteristic of one or more hardware components of the memory system, the characteristic of firmware or software for operating the memory system or the system that includes the memory system, or any combination thereof.

11. The apparatus of claim 1, wherein the second private key stored at the apparatus is associated with a manufacturer of the memory system.

12. The apparatus of claim 1, wherein the second certificate further comprises information associated with a second public key corresponding to the second private key, a second indication of the characteristic of the memory system, or both.

13. The apparatus of claim 1, wherein memory and the at least one processor are further configured to cause the apparatus to:
receive a third certificate comprising a third public key that corresponds to a third private key of the memory system, a third signature generated based at least in part on the third private key of the memory system, and an indication of an updated characteristic of the memory system;
verify, using the third public key, whether the third signature included in the third certificate is endorsed by the certificate authority associated with the third private key of the memory system;
verify whether the updated characteristic associated with the memory system is included in the set of characteristics or an updated set of characteristics stored at the apparatus; and
generate, based at least in part on verifying that the third signature included in the third certificate is endorsed by the certificate authority associated with the first private key and that the updated characteristic of the memory system is included in the set of characteristics or the updated set of characteristics stored at the apparatus, a fourth certificate that comprises the third public key and a fourth signature, the fourth signature generated based at least in part on the second private key stored at the apparatus.

14. An apparatus, comprising:
a controller configured to couple with a memory system, wherein the controller is configured to cause the apparatus to:
receive a first certificate from the memory system, wherein the first certificate comprises a first public key that corresponds to a first private key of the memory system and a first signature generated based at least in part on the first private key;
verify, using the first public key, whether the first signature included in the first certificate is endorsed by a certificate authority associated with the first private key of the memory system;
receive a second certificate from the memory system or a server, wherein the second certificate comprises a second public key and a second signature generated based at least in part on a second private key of the server; and
verify whether the second signature is endorsed by a second certificate authority associated with the second private key.

15. The apparatus of claim 14, wherein the controller is further configured to cause the apparatus to:
verify whether the second public key included in the second certificate matches the first public key included in the first certificate.

16. The apparatus of claim 15, wherein the controller is further configured to cause the apparatus to;
verify that the memory system possesses the first private key based at least in part on verifying that the second public key matches the first public key.

17. The apparatus of claim 15, wherein the controller is further configured to cause the apparatus to:
verify that the second certificate is associated with the memory system based at least in part on verifying that the second public key matches the first public key.

18. The apparatus of claim 14, wherein the controller is further configured to cause the apparatus to:
transmit, to the memory system or the server, a request for the second certificate based at least in part on verifying that the first signature is endorsed by the memory system, wherein receiving the second certificate is based at least in part on transmitting the request.

19. The apparatus of claim 14, wherein the controller is further configured to cause the apparatus to:
transmit the first certificate to the server, wherein receiving the second certificate is from the server and is based at least in part on transmitting the first certificate to the server.

20. A non-transitory computer-readable medium storing code comprising instructions which, when executed by a processor of an electronic device, cause the electronic device to:
receive a first certificate comprising a first public key that corresponds to a first private key of a memory system, a first signature generated based at least in part on the first private key of the memory system, and an indication of a characteristic of the memory system;
verify, using the first public key, whether the first signature included in the first certificate is endorsed by a certificate authority associated with the first private key of the memory system;
verify whether the characteristic of the memory system is included in a set of characteristics;
generate, based at least in part on verifying that the first signature included in the first certificate is endorsed by the certificate authority associated with the first private key and that the characteristic of the memory system is included in the set of characteristics, a second certificate that comprises the first public key and a second signature, the second signature generated based at least in part on a second private key; and
transmit the second certificate.
